(19) United States
(12) Patent Application Publication
(10) Pub. No.: US 2014/0202313 A1
(43) Pub. Date: Jul. 24, 2014

(54) COLLAPSIBLE MUSICAL KEYBOARD

(71) Applicants: Michael Prichard, Carlisle, MA (US); Jory Bell, San Francisco, CA (US)

(72) Inventors: Michael Prichard, Carlisle, MA (US); Jory Bell, San Francisco, CA (US)

(21) Appl. No.: 13/748,421

(22) Filed: Jan. 23, 2013

(51) Int. Cl. G10H 1/34

(52) U.S. Cl. CPC G10H 1/346
USPC 84/423 R

(57) ABSTRACT

Embodiments generally relate to providing a musical keyboard. In one embodiment, a keyboard includes a base characterized by a base plane, a first mechanism operably connected to the base and to a first set of keys; and a second mechanism operably connected to the base and to a second set of keys. In the closed state, the first and second mechanisms enable the plurality of keys and the second set of keys to lie in the base plane. In an open state, the first mechanism enables the first set of keys to lie in a first plane, and the second mechanism enables the second set of keys to lie in a second plane.

### BACKGROUND

Full-size musical keyboards are sometimes impractical for reasons including space, weight or portability, so a reduction in size may be desirable. Currently available compact keyboards attempt to strike a compromise between making significant reductions in size and weight and providing a playing experience close to that of playing a standard piano-style keyboard.

### SUMMARY

Embodiments generally relate to providing a musical keyboard. In one embodiment, a keyboard includes a base characterized by a base plane, a first mechanism operably connected to the base and to a first set of keys; and a second mechanism operably connected to the base and to a second set of keys. In the closed state, the first and second mechanisms enable the plurality of keys and the second set of keys to lie in the base plane. In an open state, the first mechanism enables the first set of keys to lie in a first plane, and the second mechanism enables the second set of keys to lie in a second plane.

In another embodiment, a method includes a keyboard apparatus comprising a base characterized by a base plane, a first mechanism operably connected to the base and to a first set of keys; and a second mechanism operably connected to the base and to a second set of keys. In the closed state, the first and second mechanisms enable the first set of keys and the second set of keys to lie in the base plane. In an open state, the first mechanism enables the first set of keys to lie in a first plane, and the second mechanism enables the second set of keys to lie in a second plane. The method also includes configuring the keyboard apparatus to be in the open state when the keyboard apparatus is to be played and configuring the keyboard apparatus to be in the closed state when the keyboard apparatus is not to be played.

In another embodiment a keyboard includes a base characterized by a base plane, a first mechanism operably connected to the base and to a first set of keys; and a second mechanism operably connected to the base and to a second set of keys. The first and second mechanisms are configured such that a user may change the keyboard apparatus between a closed state, in which the first set of keys and the second set of keys lie in the base plane, and an open state, in which the first set of keys lies in a first plane and the second set of keys lies in a second plane.

### BRIEF DESCRIPTION OF THE DRAWINGS

FIG. 1 is a schematic perspective view of an example keyboard apparatus in an open state, according to some embodiments.

FIG. 2 is a schematic perspective view of part of an example keyboard apparatus in an open state, according to some embodiments

FIG. 3 is a schematic perspective view of part of an example keyboard apparatus in a closed state, according to some embodiments

FIG. 4 is a schematic side view showing the spatial relationships between elements of an example keyboard apparatus in an open state, according to some embodiments.

FIG. 5 is a more detailed schematic side view showing the spatial relationships between elements of an example keyboard apparatus in an open state, according to some embodiments.

FIG. 6 is a schematic side view showing the spatial relationships between elements of the example keyboard apparatus of FIG. 4 in a closed state.

FIG. 7 is a zoomed-in schematic perspective view of part of an example keyboard apparatus in an open state showing spatial relationships between elements of an example keyboard apparatus in an open state according to some embodiments.

FIG. 8 is a schematic side view of part of an example keyboard apparatus in an open state according to some embodiments.

FIG. 9 is a schematic perspective view of an example keyboard apparatus in an open state, according to some embodiments.

### DETAILED DESCRIPTION

Embodiments described herein enable a user to enjoy a keyboard playing experience that is relatively close to that of playing a standard piano-style keyboard. Embodiments provide a keyboard that is not only of reduced size while in a playable configuration, but also readily reconfigurable into an extremely compact “collapsed” form when being transported or stored. Embodiments generally relate to providing a musical keyboard that is easily reconfigured between a closed state, in which all the keys and associated hardware are positioned in a compact, substantially planar arrangement, and an open state, in which the keys are positioned in an arrangement that provides a playing experience close to that of playing a standard piano-style keyboard.

In some embodiments, a keyboard apparatus includes a base, and a first mechanism operably connected to the base and to a first set of keys. The first set of keys may correspond, for example, to a block of adjacent white keys of part of a standard piano keyboard. The keyboard apparatus also includes a second mechanism, operably connected to the base and to a second set of keys. The second set of keys may correspond, for example, to a corresponding set of black keys of that piano keyboard. The base is typically shallow, with its upper and lower surfaces close together, so that a base plane may be defined, situated level with or close to either of those surfaces.

When the keyboard is in a closed or collapsed state, the first and second mechanisms enable the first set of keys and the second set of keys to lie in the base plane. The keyboard thus takes up very little space in this closed state. In an open or playable state, the first mechanism enables the first set of keys to lie in a first plane, while the second mechanism simultaneously enables the second set of keys to lie in a second plane. The first plane typically lies above the base plane and below the second plane, so that the corresponding sets of white and black keys lie in the relative positions expected of a standard piano-style keyboard.

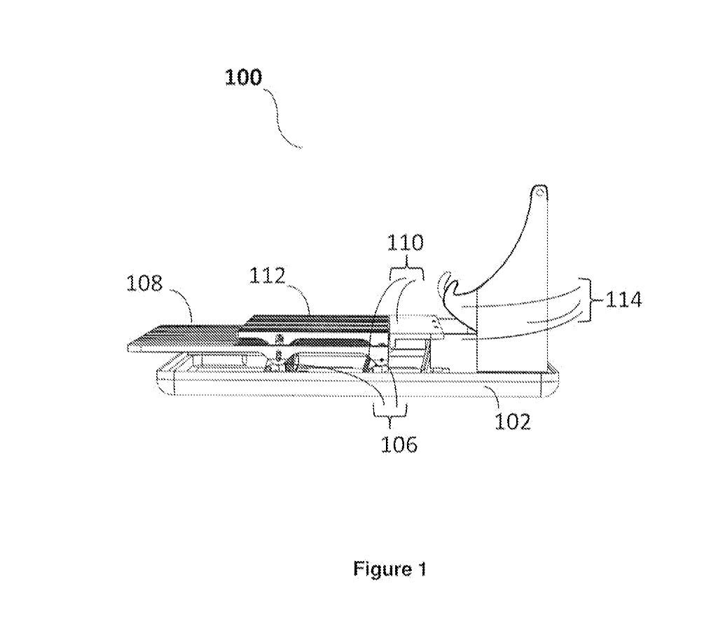

One major issue addressed by embodiments described herein is the degree to which a compact keyboard can provide a standard piano-like playing experience. Key parameters in this regard include the height differential between white and black keys, the length differential between white and black keys, the range of motion in the vertical dimension of both white and black keys, and the degree of overhang of the white keys above any underlying surface. Other parameters of some interest include the widths of the keys, in turn determining the octave span, and the sharpness of the side and front edges of the black keys. Various embodiments described below allow these parameters that determine “playability” to lie within desirable ranges, as will be described below, with particular reference to FIG. 1 through FIG. 5.

FIG. 1 is a schematic perspective view of an example keyboard apparatus 100 in an open state, according to some embodiments. Apparatus 100 includes a base 102, and a first mechanism 106 operably connected to base 102 and to a first set of keys 108 (also referred to as “white” keys 108). Apparatus 100 also includes a second mechanism 110 operably connected to base 102 and to a second set of keys 112 (also referred to as “black” keys 112). Only portions of mechanisms 106 and 110 are labeled in this figure for clarity; further details are shown in other figures as described below. Keys 108 (the “white” keys) lie in a plane below the plane in which keys 112 (the “black” keys) lie, and both sets of keys lie above the base.

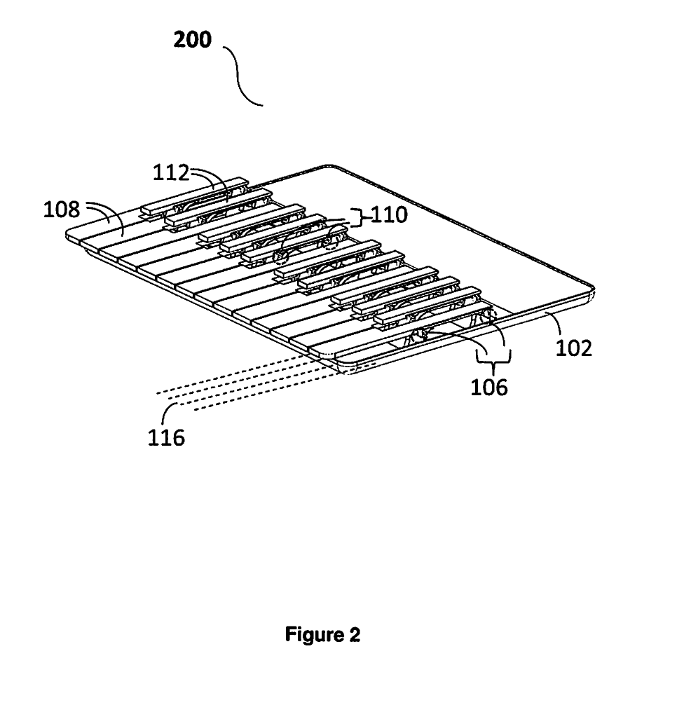

FIG. 2 is a schematic perspective view of part of an example keyboard apparatus 200 in an open state, showing more details of the structure and the relative positions of the various elements, according to some embodiments. For clarity, elements corresponding to those of FIG. 1 have been given the same labels, in this and subsequent figures. Dashed lines indicate the location of base plane 116. In this case, base plane 116 is approximately mid-way between the substantially planar top and bottom surfaces of base 102. In other cases, base plane 116 may be slightly above or below this level.

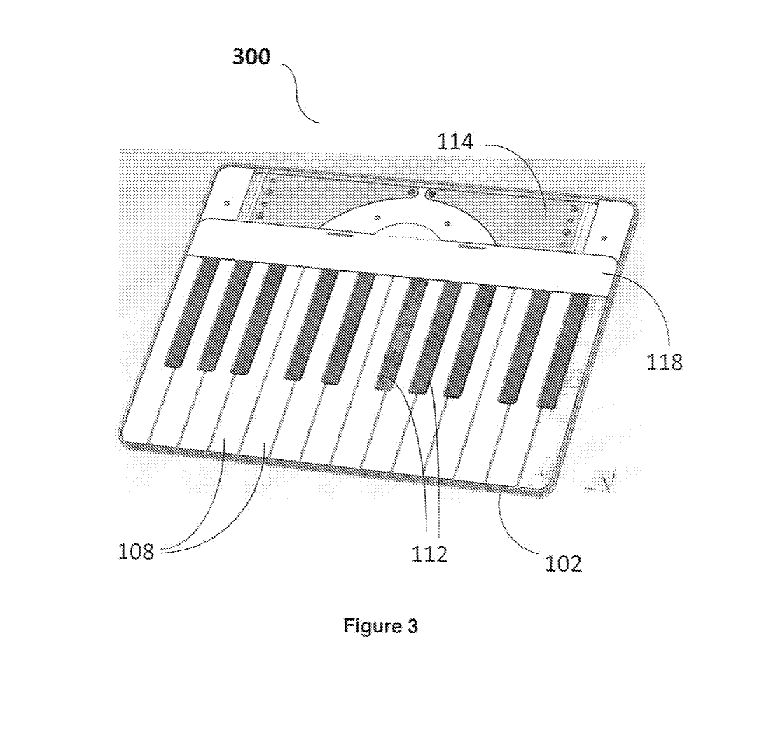

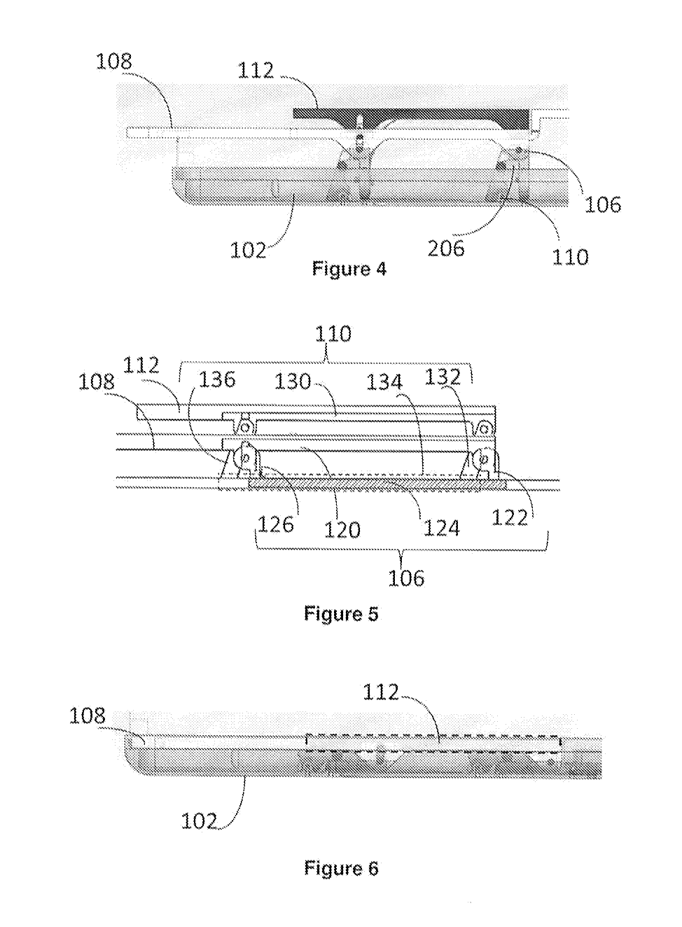

FIG. 3 is a schematic perspective view of an example keyboard apparatus 300 in a closed state, according to some embodiments. White keys 108 and black keys 112 are now shown lying in the same plane as base 102, rather than in planes elevated above base 102 as in FIG. 1 and FIG. 2. Mechanisms 106 and 110 lie underneath the keys, within the base, and hence are not seen in this figure. In some embodiments, the back edges of black and white keys may be aligned in the closed state, as shown. Ways in which the reconfiguration of the keyboard apparatus between the open and closed states may be achieved will be described below with particular reference to FIG. 4 through FIG. 7.

FIG. 4 is a schematic side view showing the spatial relationships between some elements of an example keyboard apparatus in an open state, according to some embodiments. Parts of mechanism 106 connected to white keys 108 and parts of mechanism 110 connected to black keys 112 are visible in this view, in which side surfaces of base 102 and the nearest white key 108 are rendered transparent. For clarity, not all the components of mechanisms 106 and 110 are shown in FIG. 4, and not all the components that are visible are explicitly identified and labeled as elements of those mechanisms. FIG. 5, to be discussed below, provides greater details in this regard. In the embodiments of FIG. 4, a set of half-moon linkage elements 206 synchronizes motion between mechanisms 106 and 110, allowing the white and black keys to be moved together, in synchrony. A stop (not shown) is shaped and positioned to hold mechanism 110, and thus black keys 112, in their required open-state positions, in turn holding mechanism 106 and white keys 108 in their corresponding open-state positions.

In the embodiments shown in FIG. 4, it is apparent that in the open state, while the back edges of black and white keys (shown on the right hand side of the figure) line up in the same vertical plane, the front edges of the white keys project well forward of the front edges of the black keys, and somewhat forward of the front edge of base 102.

In some embodiments, as shown in FIG. 4, mechanisms 106 and 110 involve two sets of bars (shown vertical and slightly inclined to vertical), linked to keys 108 and 112 respectively, and to at least one fixed bar (not shown) in base 102, at pivots. The resulting pivoted parallelogram configuration allows the movement of the two sets of keys 108 and 112 in planes parallel to each other and to base 102. The movement may occur between the open state, in which some type of stop may determine the range of motion in one direction (to the right in the view of FIG. 4), and the closed state, determined by another stop or by base 102 itself.

FIG. 5 is a slightly zoomed in schematic side view showing the spatial relationships between some elements of an example keyboard apparatus in an open state, according to some embodiments. In the shown embodiments, mechanism 106 takes the form of one four-bar linkage for each white key, the linkage including elements 120, 122, 124, and 126. Each white key 108 is attached to bar 120, attached to bar 122, which is attached to fixed bar 124 (shown shaded), which is attached in turn to bar 126. Bars 122 and 126 may rotate in the plane of the figure, moving bar 120, and thus key 108 in “parallelogram fashion” between open and closed states. In a corresponding way, mechanism 110 takes the form of one four-bar linkage for each black key, the linkage including elements 130, 132, 134, and 136. Each black key 112 is attached to bar 130, attached to bar 132, which is attached to fixed bar 134 (indicated by a dashed outline), which is attached in turn to bar 136. Bars 132 and 136 may rotate in the plane of the figure, moving bar 120, and thus key 108 in “parallelogram fashion” between open and closed states.

In other embodiments, not shown, mechanisms other than four-bar linkages may be used to achieve the same result of moving the sets of black and white keys between the desired open and closed states. In some embodiments, elements other than half-moon linkages may be used to synchronize the motion of mechanisms 106 and 110.

FIG. 5 is a schematic side view showing the spatial relationships between elements of the example keyboard apparatus of FIG. 4 in a closed state, according to some embodiments. White key 108, closest to the viewer of the figure, is shown transparent, and lying within the volume enclosed by base 102. Adjacent black key 112 is shown with a dashed outline, lying immediately behind white key 108, also within the volume enclosed by base 102. Mechanisms 106 and 110 cooperate to allow the movement (or collapse) of all the keyboard keys into this compact, closed configuration, and the movement (or expansion) of these elements back into the open state when desired. In the shown embodiment, this cooperation is facilitated by the presence of synchronizing element 206. A set of synchronizing elements 206 may be present to provide coordination between the motions of the first and second sets of keys, 108 and 112.

In various embodiments, reconfiguration of the keyboard between open and closed states is achieved with simple mechanical manipulation by the user, releasing any stops, and pulling or pushing at a single site to operate the combination of mechanisms 106 and 110. In some implementations, the user is enabled to conveniently reconfigure the keyboard between open and closed states as desired; an expanded three-dimensional state, in which the keyboard is fully playable, and a collapsed, substantially two-dimensional state, in which the keyboard occupies minimal space.

For the embodiments shown in FIG. 4 and FIG. 5, it is apparent that to reach the closed state from the open state, or vice versa, the synchronized pivoting linkage mechanisms have to move the black keys through a greater vertical distance, and a correspondingly greater angular rotation, than the vertical distance and rotation through which the white keys must be moved. In one particular design, the angular rotations found to be necessary were 90 degrees for the black keys and 70 degrees for the white keys.

Various embodiments discussed herein and shown in the corresponding drawings provide sufficient space between the planes of the black and white keys to result in a height differential close to that found with full-size standard musical keyboards. This avoids a potential issue of a reduced height differential that may make it hard for a user's finger to avoid hitting a white key when a black key is fully depressed. As the keyboard effectively folds flat when required, a relatively large height differential in the open state may easily be provided, without impacting convenience in other ways. See, for example, the ample vertical spaces between black and white keys shown in FIG. 1, FIG. 2, and FIG. 4, for the open state of some embodiments, and contrast these with the collapsed arrangements shown in FIG. 3 and FIG. 5.

Various embodiments discussed herein and shown in the corresponding drawings allow the portion of the length of each white key extending beyond the full length of the black keys to be close to the length typical of keys in full-size standard keyboards. This avoids a potential issue of a reduced available space between the front edges of the black and white keys that may make it hard for a user's finger to avoid hitting a black key when an adjacent white key is depressed. Again, the compactness of the collapsed state of the keyboard, shown in FIG. 3 and FIG. 5, allows a relatively long key length to be provided without undue increase in total keyboard volume.

Various embodiments discussed herein and shown in the corresponding drawings allow the range of motion of the keys, in the vertical dimension, to be close to the ranges typical with full-size keyboards. A range of approximately 12 mm, typical for white keys in standard keyboards, may be provided, while a slightly smaller range may be provided for the black keys. This avoids a potential issue of reduced available space underneath the white and black keys that may make the user experience disturbingly different from that of playing a standard musical keyboard. Again, as the keyboard effectively folds flat, to the form shown in FIG. 3 and FIG. 5, when desired, suitably large spaces may be provided under the keys in the open state, shown in FIG. 1, FIG. 4 and FIG. 5, without impacting convenience in other ways.

Various embodiments discussed herein and shown in the corresponding drawings allow the set of white keys to overhang base 102 of the keyboard. This avoids a potential issue of the wrists or heels of the user's hands being constrained to avoid contact with an underlying surface while playing. Various embodiments are designed to allow the white keys to project sufficiently far forward beyond the front edge of the underlying base, so that the keyboard player's wrists have the same constraints or lack of constraints as when playing a standard piano keyboard. The embodiments of FIG. 1 and FIG. 4 show that considerable extension or overhang may be provided in the open state, without impacting the width of the collapsed keyboard in the closed state, as shown in FIG. 3 and FIG. 5.

It has been found that reducing key widths, and corresponding octave spans, is generally quite acceptable to keyboard players. Indeed, the sizes of these parameters were set to their currently standard values relatively recently in the history of musical keyboards. While some embodiments may incorporate standard key widths, corresponding to an octave span of about 6.5 inches, it has been found that slightly reduced widths, corresponding to an octave span of the order of 5 inches, may be used without a significant impact on playability. It has also been found that providing two full octaves in a compact keyboard is sufficient to satisfy most users, so many embodiments are designed to provide just those two. In cases where four, six, or even eight octaves are desired, various embodiments lend themselves to a “daisy-chaining” arrangement.

Referring once more to FIG. 3, a shelf 118 is shown lying beyond keys 108 and 112 in the same base plane. In the open state, shelf 118 may be moved in a similar way to the two sets of keys, using a similar synchronized linkage mechanism, to lie in a plane above the base plane. Shelf 118 may be used to hold a physical knob or slider mechanism directly controllable by the keyboard player to enhance the playing or recording of music played on the keyboard. Such a knob or slider could provide haptic feedback to the user. In some implementations, electronic circuitry may be situated under shelf 118 or in other spaces within base 102 that are not required to hold other elements of the keyboard in either open or closed states.

FIG. 6 is a zoomed-in perspective view showing the spatial relationships between elements of an example keyboard apparatus in an open state, according to some embodiments. Specifically, one of the synchronization elements 206 and its relationship to parts of mechanisms 106 and 110 are indicated. For clarity, only those components of mechanisms 106 and 110 that are clearly visible in the figure are labeled; these being bar 122 and pivot 123, connecting bar 122 to white key 108, and bar 132 and pivot 133, connecting bar 132 to black key 112. Synchronization element 206 is clearly visible in this view, connecting to bars 122 and 132 through rods indicated by the white and black cylindrical protrusions near each end of the half-moon shape.

In the embodiments of FIG. 6, there are no bars corresponding to bars 120 and 130 of the FIG. 5 embodiments, as bars 122 and 126 connect directly to key 108, and bars 132 and 136 connect directly to key 112. In various embodiments, there may be no bars corresponding to bars 124 and 134, as bars 122 and 126 may connect directly to fixed base 102, and bars 132 and 136 may connect directly to fixed base 102.

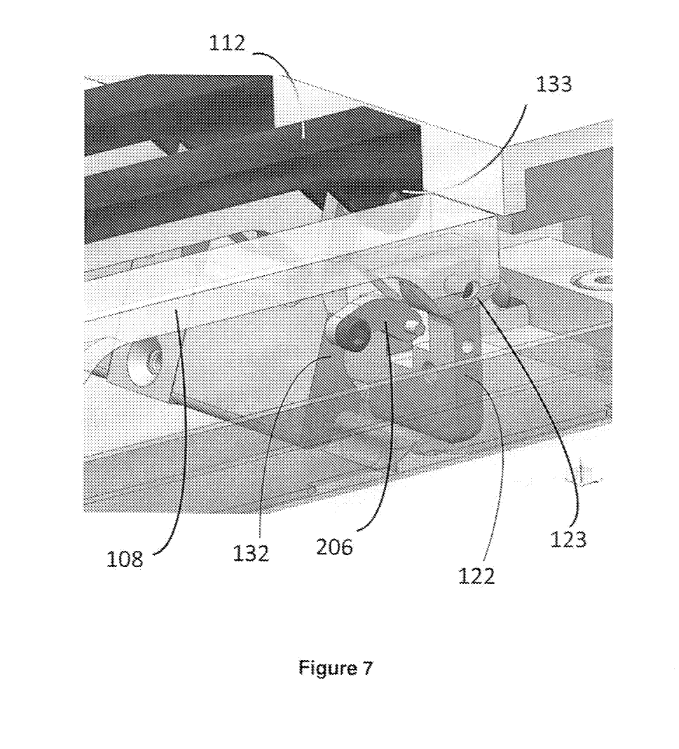

FIG. 7 is a schematic side view of part of an example keyboard apparatus 700 in an open state, according to some embodiments. This view shows leaf spring elements 208 and 210, positioned beneath white key 108 and black key 112 respectively. Each key of the keyboard is addressed by a corresponding leaf spring finger element. These spring elements provide the necessary tensile restoring forces when either key is depressed by a user, giving the user the expected “feel” of resistance during play. In the particular embodiment shown, leaf spring elements 208 and 210 are fingers of a transversely positioned larger spring element (not shown) lying across the width of the keyboard. This larger spring element is configured such that leaf spring elements 208 and 210 are positioned slightly beneath keys 108 and 112 in the open state as shown, and such that leaf spring elements and the larger spring element are moved in synchrony with the two sets of keys to lie flat beneath the keys in the base plane when the keyboard is in the closed state. This synchronized motion may be achieved in some embodiments by the same type of synchronized four bar linkages discussed above and shown, for example, in FIG. 6.

In various other embodiments, mechanisms other than multi-fingered leaf springs may be used to achieve the same results discussed above. In various embodiments, the mechanisms are chosen such that they do not interfere with access to the keys' top surfaces, do provide the necessary restoring forces to keys depressed during play, and may be moved to lie in or close to the base plane when the keyboard in in the closed state.

In some embodiments, apparatus 100 includes a holder 114, attached to base 102 and configured to act as a stop, securing the first mechanism and the second mechanism in a predetermined position when the keyboard is in the open state. Such an arrangement is shown in FIG. 1, with the securing mechanism being the lower left portion of holder 114. In these embodiments, holder 114 lies in base plane 116 when the keyboard is in the closed state. This configuration is shown in FIG. 3.

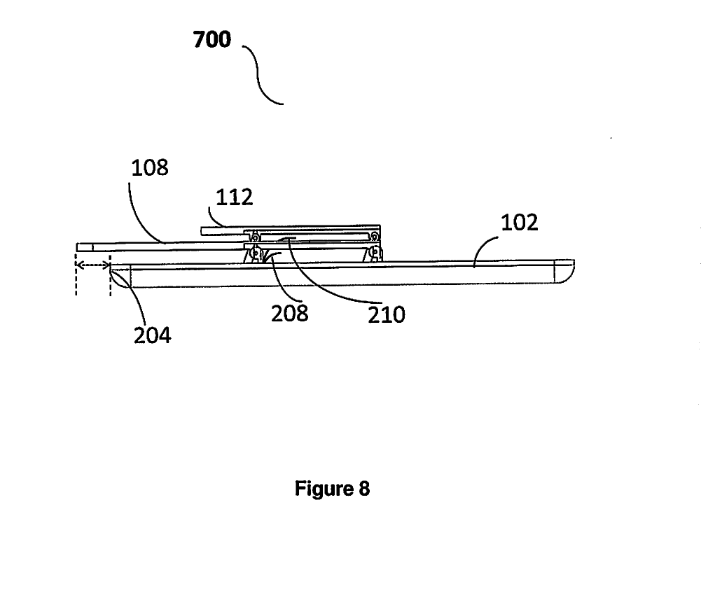

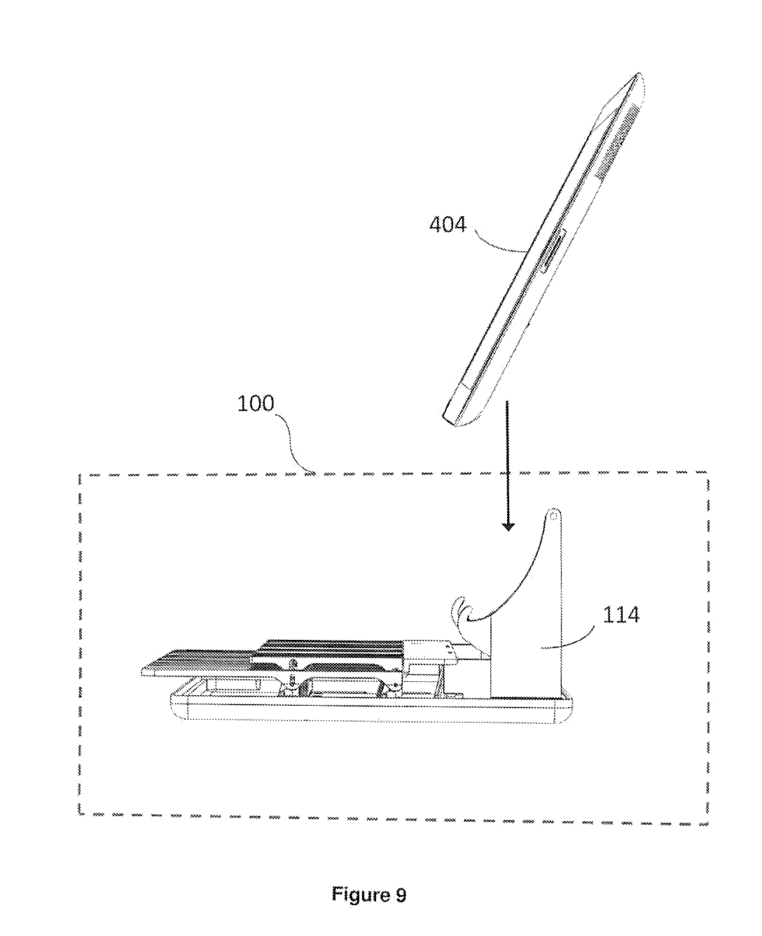

FIG. 8 is a schematic perspective view of example keyboard apparatus 100 in an open state, according to some embodiments, in which holder 114 is configured to support an object 404 viewable by a user of the keyboard apparatus. For clarity, the figure shows object 404 at some vertical distance above holder 114, as if about to be positioned therein. In some embodiments, object 404 is a tablet computer; in fact, the dimensions of keyboard apparatus 100 may be designed to have a footprint that is compatible with the standard sizes of widely available tablet computers. The resulting keyboard is then particularly convenient to use with such devices. In the open state, the user may, for example, read and follow music displayed on the device, follow stored or real time instructions, or be accompanied by music played by the computer. In the closed state, both keyboard and tablet may be encapsulated in a single, relatively compact case.

In other embodiments, object 404 may be any other type of electronic display or computing device, or a passive display medium such as sheet music.

In some embodiments, the black keys are designed to have rounded side and/or front edges, to more closely approximate the experience of playing a standard piano keyboard.

Embodiments described herein provide various benefits. In particular, embodiments enable professional and non-professional musicians to enjoy a playing experience similar in many important respects to that of playing a standard piano keyboard, while avoiding the inconvenience of size and weight inherent in such an instrument. These benefits may be especially valuable to the mobile user.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in”, “on”, and “in close proximity to” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A keyboard apparatus comprising:
a base characterized by a base plane;
a first mechanism operably connected to the base and to a first plurality of keys; and
a second mechanism operably connected to the base and to a second plurality of keys, wherein in a closed state, the first and second mechanisms enable the first and second pluralities of keys to lie in the base plane, wherein in an open state, the first mechanism enables the first plurality of keys to lie in a first plane, and wherein in the open state, the second mechanism enables the second plurality of keys to lie in a second plane.

2. The keyboard apparatus of claim 1, further comprising a synchronization mechanism connecting the first mechanism and the second mechanism.

3. The keyboard apparatus of claim 1, wherein the base has a front edge, and wherein in the open state, the first plurality of keys projects beyond the front edge.

4. The keyboard apparatus of claim 1, wherein in the open state, each key of the first and second pluralities of keys is depressible towards the base plane independently of any other key of the first and second pluralities of keys.

5. The keyboard apparatus of claim 1, further comprising a holder attached to the base, wherein in the closed state, the holder lies in the base plane, and wherein in the open state, the holder is configured to secure the first mechanism and the second mechanism in a predetermined position.

6. The keyboard apparatus of claim 5, wherein the holder is further configured to support an object viewable by a user of the keyboard apparatus.

7. The keyboard apparatus of claim 6, wherein the object is a tablet computer.

8. The keyboard apparatus of claim 6, wherein the object is sheet music.

9. A method comprising:
providing a keyboard apparatus comprising:
a base characterized by a base plane;
a first mechanism operably connected to the base and to a first plurality of keys; and
a second mechanism operably connected to the base and to a second plurality of keys; wherein in a closed state, the first and second mechanisms enable the first plurality of keys and the second plurality keys to lie in the base plane, wherein in an open state, the first mechanism enables the first plurality of keys to lie in a first plane, and wherein in the open state, the second mechanism enables the second plurality of keys to lie in a second plane;
configuring the keyboard apparatus to be in the open state when the keyboard apparatus is to be played; and
configuring the keyboard apparatus to be in the closed state when the keyboard apparatus is not to be played.

10. The method of claim 9, wherein configuring the keyboard apparatus to be in the open state and configuring the keyboard apparatus to be in the closed state are achieved using a synchronization mechanism connecting the first mechanism and the second mechanism.

11. The method of claim 9, wherein the base has a front edge, and wherein in the open state, the first plurality of keys projects beyond the front edge.

12. The method of claim 9, wherein in the open state, each key of the first and second pluralities of keys is depressible towards the base plane independently of any other key of the first and second pluralities of keys.

13. The method of claim 9, wherein the keyboard apparatus further comprises a holder attached to the base, wherein in the closed state, the holder lies in the base plane, and wherein in the open state, the holder is configured to secure the first mechanism and the second mechanism in a predetermined position.

14. The method of claim 13, wherein the holder is further configured to support an object viewable by a user of the keyboard apparatus.

15. The method of claim 14, wherein the object is a tablet computer.

16. The method of claim 15, wherein the object is sheet music.

17. A keyboard apparatus comprising:
a base characterized by a base plane;
a first mechanism operably connected to the base and to a first plurality of keys; and
a second mechanism operably connected to the base and to a second plurality of keys;
wherein the first and second mechanisms are configured such that a user may change the keyboard apparatus between a closed state, in which the first and second pluralities of keys lie in the base plane, and an open state, in which the first plurality of keys lies in a first plane and the second plurality of keys lies in a second plane.

18. The keyboard apparatus of claim 17, wherein the change of the keyboard apparatus between the closed state and the open state is achieved using a synchronization mechanism connecting the first mechanism and the second mechanism.

19. The keyboard apparatus of claim 17, wherein the base plane, the first plane and the second plane are substantially parallel.

20. The keyboard apparatus of claim 17, wherein in the open state, each key of the first and second pluralities of keys is depressible towards the base plane independently of any other key of the first and second pluralities of keys.
